(19) United States
(12) Patent Application Publication
(10) Pub. No.: US 2003/0016212 A1
(43) Pub. Date: Jan. 23, 2003

(54) Method, computer program product and device for wireless connection

(76) Inventor: Stefan Lynggaard, Lund (SE)

Correspondence Address: BIRCH STEWART KOLASCH & BIRCH, PO BOX 747, FALLS CHURCH, VA, 22040-0747, US

(21) Appl. No.: 10/179,964

(22) Filed: Jun. 26, 2002

Related U.S. Application Data
(60) Provisional application No. 60/302,389, filed on Jul. 3, 2001.

(30) Foreign Application Priority Data
Jun. 27, 2001 (SE) 0102279-7

(51) Int. Cl. G09G 5/08; G09G 5/00

(52) U.S. Cl. 345/179

(57) ABSTRACT

The invention relates to a method for connecting a sensor device, e.g. an electronic pen, to an arbitrary external unit. The method comprises electronically recording by means of the sensor device, on a base provided with at least one subset of a position-coding pattern which codes pairs of coordinates on an imaginary surface, a pair of coordinates within a first subarea among a plurality of subareas within an addressing area on the imaginary surface, calculating a number for the first subarea based on the pair of coordinates, and connecting the sensor device to the external unit via an address for electronic communication, which corresponds to the number.

Furthermore the invention comprises a device and a computer program product for connecting a sensor device to an external unit, and a method and a device for coding addresses for electronic communication.

### FIELD OF THE INVENTION

The present invention relates to a method, computer program product and a device for establishing a connection of a sensor device to external communication equipment without using a computer network. The invention also relates to a method and a device for coding addresses for electronic communication.

### BACKGROUND ART

For a first unit, such as a sensor device, e.g. an electronic pen, to be connected wirelessly to a second, arbitrary external unit via short range communication, it is required that the first-mentioned know the latter's unique address so that information sent reaches the intended recipient. For this purpose, the first unit may have a memory function, a database, for previously known addresses. In the database, each address is associated with a certain type of function, e.g. printer, modem or mobile phone, and when information is to be sent to, for instance, the printer, the address of the printer is retrieved in the database and used for the communication.

When a unit is introduced for the first time in an environment where other units are located, a it may perform an interrogation procedure, by which an interrogating signal is sent at regular intervals from the newly introduced unit. Each unit in the environment answers this signal by sending its address, and in this manner the newly introduced unit makes up a database of addresses of units in the neighborhood. However, this procedure may be time-consuming if there are many units in the neighborhood, especially if connection to a specific unit only is desired. Another problem of this procedure is that it does not always result in the correct unit being found since all units within range may not be available for responding to interrogations. Another fashion of indicating an address for communication is manual input of the address of the specific unit. This procedure is, still more than the first mentioned, associated with slow input as well as sources of error, such as incorrect inputting being carried out by the user. Moreover, a user interface must be available for the input to take place.

An object of the present invention thus is to provide a technique for quick, simple and correct connection of a sensor device to a previously unknown communication unit.

### SUMMARY OF THE INVENTION

The above objects are wholly or partly achieved by methods according to the independent claims 1 and 16, a device according to claims 13 and 21 and 25, as well as a computer program product according to claim 12. Embodiments of the invention are apparent from the dependent claims and from the following description.

A first aspect of the invention provides a method for connecting a sensor device to an arbitrary external unit. The method comprises electronically recording, by means of the sensor device, on a base provided with at least one subset of a position-coding pattern which codes pairs of coordinates on an imaginary surface, a pair of coordinates within a first subarea among a plurality of subareas within an addressing area on the imaginary surface, calculating a number for the first subarea based on the pair of coordinates, and connecting the sensor device to the external unit via an address for electronic communication, which corresponds to the number.

Such a method enables connection of the sensor device directly to the address that corresponds to the pair of coordinates recorded by the sensor device. In this manner, the sensor device need not carry out any interrogation procedure as in prior art, but connection is obtained by the address being derived from at least one of the pairs of coordinates which are inputted from the base.

According to an embodiment, a pair of coordinates can be precisely a pair of, i.e. two, coordinates which indicate a position in a two-dimensional coordinate system. A pair of coordinates according to the invention should, however, be interpreted in a wider sense, viz. as the set of a number of m coordinates which are necessary in order to determine a position for a dot in an m-dimensional coordinate system. Such sets of coordinates, however, preferably comprise at least two coordinates.

The number may be calculated based on a mathematical relationship for the locations of said plurality of subareas within the addressing area on the imaginary surface. This enables identification of the number or the address without keeping an excessively large amount of data in the memory of the sensor device. For example, the method may comprise retrieving a reference number for a reference subarea among said plurality of subareas from a memory unit, within the sensor device, and calculating the number based on the reference number, the pair of coordinates and the mathematical relationship for the locations of said plurality of subareas on the imaginary surface.

The method may also comprise retrieving a pair of reference coordinates for the reference subarea from the memory of the sensor device, whereby the pair of reference coordinates is utilized when calculating the number.

The number may correspond to, or constitute, an address for wireless short-range communication, such as an address for a short range radio link or an address for a short-range infrared link. Other similar addresses are also conceivable.

Furthermore, the method may comprise electronically recording by means of the sensor device a second pair of coordinates within a second subarea comprised in the addressing area on the imaginary surface, and calculating based on the second pair of coordinates a second number for the second subarea, the step of connecting the sensor device to the external unit being carried out based on a combination of said number and said second number. In this way, an address for communication may be constructed by a plurality of inputs of pairs of coordinates into the sensor device, which may be advantageous if it is desirable to enable the user to select one out of many external units to be connected to, or if it is desirable to address a very large number of external units using a limited addressing area. In a similar way, the method according to the invention may also comprise deriving further addresses corresponding the respective subareas of the addressing area. It is also conceivable that the modification of the number comprises a calculating operation, which results in a number of secondary numbers. In this way, connection or attempted connection to a plurality of external units may be enabled based on a recording of one or a few pairs of coordinates.

According to a second aspect, the method may be implemented as a computer program product for carrying out connection of a sensor device to an arbitrary external unit. The computer program product may comprise instructions for the sensor device. Such a computer program product may be distinguished in that the instructions, when executed, cause the sensor device to perform the method described above.

According to a third aspect, there is provided a device for carrying out connection of a sensor device to an arbitrary external unit. The device may comprise a signal processor, which is arranged for receiving a pair of coordinates, which is electronically recorded from a base provided with at least a subset of a position-coding pattern, which codes pairs of coordinates on an imaginary surface. The signal processor is further arranged for calculating an address for electronic communication based on the position of the pair of coordinates within an addressing area on the imaginary surface; and for connecting the sensor device to the external unit via the calculated address. The signal processor may be any type of signal processing apparatus, e.g. a general programmable processor or a special-purpose signal processor.

The signal processor may be arranged to calculate, if the pair of coordinates is situated within the addressing area on the imaginary surface, a number for said pair of coordinates, based on its belonging to one of a plurality of subareas within the addressing area, and to convert this number into said address. Furthermore, the device may comprise a comprising a memory in which a mathematical relationship for the locations of said plurality of subareas on the imaginary surface is stored, said signal processor being arranged to calculate said number using said relationship. The memory may be any type of data memory, e.g. any sort of standard-type RAM, ROM, flash-memory or other volatile or non-volatile data memories or combinations thereof.

According to this third aspect, the method may be performed by application-specific circuits, such as ASICs. The invention may also be implemented in other manners, such as with a software controlled processor, or a combination of software and hardware. The reception of the pair of coordinates preferably takes place in the same physical unit as the calculation, but it is also possible for different parts of the method to be performed by different physical units.

As an alternative, the step of receiving a pair of coordinates may, in this context, be interpreted as receiving the pair of coordinates from a sensor or from an image processing unit, which based on information from the sensor has extracted the pair of coordinates. Thus, reading and interpretation of read data may be performed in a separate unit, while calculation of the address is performed in the sensor device. It is also possible to let the sensor device be the unit that inputs the pair of coordinates, in which case calculation and connection take place in another unit.

It is also conceivable to implement the invention as a combination of said second and third aspects, certain parts being implemented as computer programs and other parts being implemented in the form of application-specific circuits.

According to a fourth aspect, there is provided a method for coding addresses for electronic communication. The method is distinguished by allocating an addressing area on an imaginary surface, which is defined by all pairs of coordinates which a position-coding pattern is capable of coding, and dividing said addressing area into a plurality of subareas, assigning a number to each subarea, said number being calculable based on a predetermined mathematical relationship for the locations of the subareas within the addressing area on the imaginary surface, and, with each number, associating an address for electronic communication.

This method enables coding of a large number of addresses for electronic communication by means of an existing position-coding pattern and with a minimum storing requirement in the device that is to be connected. Moreover, quick and simple connection of units is allowed when the interrogation procedure is avoided wholly or partly in favor of direct connection to derived addresses.

Furthermore the method according to this fourth aspect can comprise the act of assigning a reference number to a reference subarea among said plurality of subareas, the reference number being used for calculation of the number. The reference number is preferably stored in the devices that should be able to derive the addresses.

The method can also comprise the act of determining a calculable relationship between the address and the number. The calculable relationship can also be stored in the devices that should be able to derived the addresses, so that the devices with a minimum of stored information can calculate the number and, thus, derive the address for electronic communication. The address may, but need not necessarily, be identical with the number.

Said plurality of subareas are may be formed in such manner that the subareas are arranged as a sequence of neighboring subareas on the imaginary surface. As a result, the calculable relationship between the subareas is easy to calculate and survey.

According to a fifth aspect, the there is provided a device for addressing electronic communication equipment. The device comprises a base provided with at least one subset of a position-coding pattern which codes pairs of coordinates on an imaginary surface. The device is distinguished in that the subset of the position-coding pattern, which is arranged on the base, corresponds to a subarea among a plurality of subareas within an addressing area on the imaginary surface, whereby a number is assigned to each such subarea, said number being calculable based on an arbitrary pair of coordinates within the subarea and a predetermined mathematical relationship for the locations of the subareas within the addressing area, and whereby the number is associated with an address for electronic communication.

The device can be a base with printed information, where at least a part of the base is provided with a subset or a portion of an extensive machine-readable position-coding pattern. The base can consist of paper, cardboard, plastic or some other suitable material. The subset of the position-coding pattern that is applied on the base may be applied on the base in a suitable fashion such as by, for example, graphic printing or printing by a data printer.

The subset of the position-coding pattern, which is arranged on the base may correspond to a subarea included in a predetermined sequence of subareas within the addressing area on the imaginary surface, so that the location of each subarea in the addressing area is calculable in relation to a reference subarea, which is also a part of the addressing area. An address for electronic communication may be calculable based on the number. The number may itself be an address for electronic communication, which reduces the amount of data that has to be stored in the sensor device and/or the amount of calculations that must be made by the sensor device in order to derive the address.

According to a sixth aspect of the invention, there is provided a device for carrying out connection of a sensor device to an arbitrary external unit. Such a device may comprise means for receiving a pair of coordinates, which is electronically recorded from a base provided with at least a subset of a position-coding pattern, which codes pairs of coordinates on an imaginary surface, means for calculating an address for electronic communication based on the position of the pair of coordinates within an addressing area on the imaginary surface, and means for connecting the sensor device to the external unit via the calculated address. The means for calculating may be arranged to calculate, if the pair of coordinates is situated within the addressing area on the imaginary surface, a number for said pair of coordinates, based on its belonging to one of a plurality of subareas within the addressing area, and converting this number into said address. The device may further comprise memory means in which a mathematical relationship for the locations of said plurality of subareas on the imaginary surface is stored, said means for calculating being arranged to calculate said number using said relationship.

### BRIEF DESCRIPTION OF THE DRAWINGS

The invention will now be described in more detail with reference to the accompanying schematic drawings which by way of example illustrate embodiments of the invention according to some different aspects.

FIG. 1 shows a system in which the method according to the invention can be used.

FIG. 2 schematically illustrates an embodiment of an addressing area on an imaginary surface, which is defined by those coordinates that are coded by the position-coding pattern.

FIG. 3 schematically shows the connection between a position-coded field on a base and an addressing area on the imaginary surface.

FIG. 4 shows a sensor device according to an embodiment of the invention.

FIG. 5 shows a flow chart of a method according to an embodiment of the invention.

FIG. 6 illustrates a detail of the flow chart in FIG. 5.

FIG. 7 shows a flow chart of a method according to an alternative embodiment of the present invention.

### DETAILED DESCRIPTION OF THE PREFERRED EMBODIMENT

The present invention has a large number of applications, which have the feature in common that a sensor device is to be connected to a previously unknown unit.

In the following the invention will first be placed in a context in order to illustrate its applicability. Subsequently suitable hardware will be described, and after that the principles and methods on which the solution according to the invention is based. Finally, three exemplifying embodiments of the present invention will be outlined.

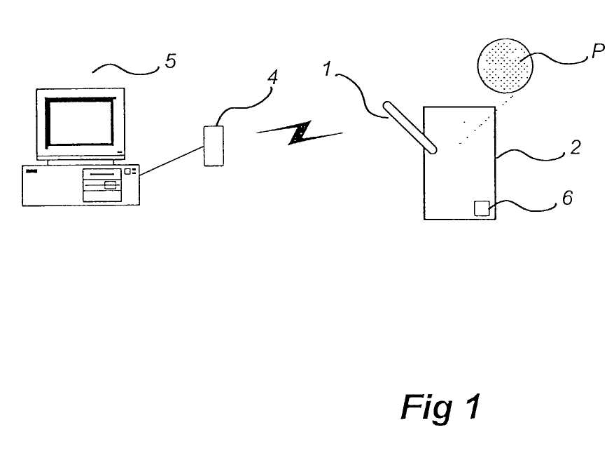

For the purpose of describing the invention in a simple way, an order form 2, such as a menu at a restaurant, is used in FIG. 1 as an illustrative example.

The order form 2, consisting of a base—usually a sheet of paper—on which a number of options are presented, is provided with fields 3 intended to be marked by an orderer. According to the embodiment of the invention, each such field 3 is provided with a subset of a position-coding pattern P. The position-coding pattern P codes a plurality of positions which together defines a two-dimensional coordinate system, which in the following is referred to as an imaginary surface. By reading the position-coding pattern, orders that are made by an orderer can be directly digitized using a sensor device 1 that will be described below, and transferred to an external unit 5 for further processing.

The position-coding pattern P is shown only schematically as a dotted surface in the drawings. This position-coding pattern is used to record what is being written on the base in electronic form. Different kinds of position-coding patterns that can be used for this purpose are previously known. U.S. Pat. No. 5,477,012, which is hereby incorporated by reference, discloses, for instance, a position-coding pattern where each position is coded with a unique symbol. The position-coding pattern can be read with a pen which optically detects the position code; decodes the position code and generates pairs of coordinates which describe the movement of the pen across the surface. WO 00/73983 and WO 01/26032, which are hereby incorporated by reference, and which have both been assigned to the applicant of the present application, describe a different position-coding pattern where each position is coded by means of a plurality of symbols of a simpler type, each symbol contributing to the coding of more than one position. According to WO 00/73983, dots of different sizes are used to code ones and zeros in the position-coding pattern which is binary. According to WO 01/26032, use is made of four different displacements of a dot from a nominal position in order to code four different bit pairs in the position-coding pattern. A certain number of dots, for instance 6*6 dots, code a unique position. The position can be calculated based on the bit values corresponding to the dots.

The position-coding patterns according to WO 00/73983 and WO 01/26032 can be detected optically with a pen which decodes the dots and generates a pair of coordinates for each set of e.g. 6*6 dots. If the position-coding pattern is read while the pen is writing on the position-coded base, a sequence of pairs of coordinates is thus obtained, which describes the movement of the pen across the position-coding pattern and which thus constitutes an electronic representation of what is being written on the base.

It will be assumed below that the base 2 is provided with a position-coding pattern of the type as disclosed in WO 01/26032.

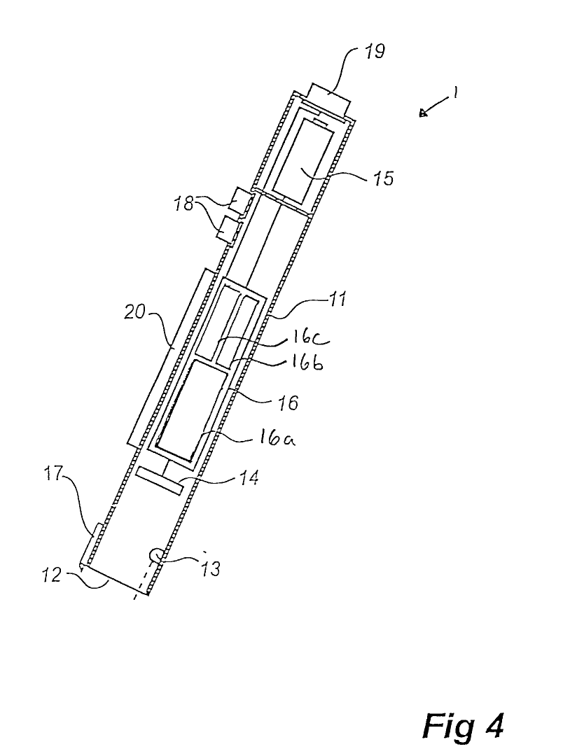

The sensor device 1 can then also be of a type as disclosed in WO 01/26032. An example of the construction of such a device will be described below with reference to FIG. 4.

The sensor device 1 comprises a casing 11 having approximately the same shape as a pen. In one short side of the casing there is an opening 12. The short side is intended to abut against or be placed a short distance from the surface on which the position determination is to take place.

The casing essentially contains an optics part, an electronic circuitry part and a power supply.

The optics part comprises at least one light-emitting diode 13 for illuminating the surface which is to be imaged, and a light-sensitive area sensor 14, such as a CCD or a CMOS sensor, for recording a two-dimensional image. Optionally the device may also comprise an optical system, such as a mirror and/or lens system (not shown). The light-emitting diode can be an infrared light-emitting diode, and the sensor can be sensitive to infrared light.

The power supply for the device is obtained from a battery 15 which is mounted in a separate compartment in the casing. It is also conceivable to achieve the power supply via a cable from an external power source (not shown).

The electronic circuitry part comprises a signal processor 16 which comprises a processor 16a having a working store 16b and a program store 16c. The processor 16a is programmed to input images from the sensor, to detect the position-coding pattern in the images and to decode this to positions in the form of pairs of coordinates, and to process the information thus recorded in electronic form in the manner that will be described in more detail below for transfer to the external unit 5 (FIG. 1) . This unit 5 may be a computer or any other unit provided with a processor, which in response to data from the sensor device 1 is programmed to perform certain actions. Recapturing the above illustrated example with the order form, the unit 5 may be programmed to initiate an order procedure in a logistics system based on information from the sensor device 1.

Moreover the sensor device 1 comprises in this embodiment a pen point 17 by means of which the user can write ordinary pigment-based writing on the surface on which the position determination is to take place. The pen point 17 can be retractable and extendable so that the user can control whether it is to be used or not. In some applications, the device need not have a pen point at all.

Conveniently, the pigment-based writing is of a type that is transparent to infrared light and the position-coding pattern is absorbing infrared light. By using a light-emitting diode which emits infrared light, and a sensor which is sensitive to infrared light, the detection of the pattern takes place without the above-mentioned writing interfering with the pattern.

The sensor device 1 may also comprise buttons 18, by means of which the user can activate and control the device. The device can also have a transceiver 19 for wireless transfer, for instance using IR light, radio waves or ultrasound, of information to and from the device. The device may further comprise a display 20 for showing positions or recorded information.

The sensor device 1 can be divided into different physical casings, e.g. a first casing containing components which are necessary to take images of the position-coding pattern and to transfer these to components which are positioned in a second casing and which carry out the position determination based on the recorded image or images.

To make an order using the order form 2 (FIG. 1), the user marks the field 3 associated with the desired option by means of the pen point of the sensor device 1, while at the same time the sensor device 1 locally reads the position-coding pattern and converts this to one or more pairs of coordinates. Thus, to carry out the order, at least one pair of coordinates, or a part thereof, must be transferred from the sensor device 1 to the unit 5. This unit 5 has knowledge of the imaginary surface, or at least a relevant part thereof, and can thus identify an order, e.g. options marked by the user of the sensor device 1, by mapping received pairs of coordinates to the imaginary surface. To be able to transfer the pairs of coordinates to the unit 5, it is necessary to establish communication between them. According to an embodiment of the present invention, the unit 5 is provided with a short-range transceiver 4 (FIG. 4), e.g. a radio transceiver according to the Bluetooth® standard, which is described in more detail at, for instance, www.bluetooth.com, or according to a WLAN-standard (e.g. IEEE 802.11). Also other types of transceivers are conceivable such as infrared transceivers according to the IrDA standard, which is described in more detail at www.irda.org. The example below, however, assumes that the communication is according to the Bluetooth® standard.

The sensor device 1 communicates, according to the embodiment described below, wirelessly with external units via its transceiver 19 (FIG. 4), in a manner known to the person skilled in the art.

Since each transceiver, according to the Bluetooth® standard has a unique 48 bit address (according to IEEE 802) through which communication takes place, it is necessary for the transceiver 19 in the sensor device 1 to obtain the address of the transceiver 4 of the unit 5. A total of 2³² different addresses can be coded according to the standard. The address of a unit is used as part of almost all transmitted data that is intended to be picked up by the unit. An address according to the Bluetooth® standard consists of one part which is company specific and assigned to each company which is to supply products based on the standard. Moreover, the address consists of one part which is product specific and determined by the company that supplies the product.

According to the invention, the base 2 (FIG. 1) is provided with an addressing field 6, which contains a subset of the position-coding pattern, the subset being formed such that the sensor device 1, based on the pairs of coordinates coded by the subset, can calculate an address to the transceiver 4 of the unit 5. Subsequently, the sensor device 1 may connect itself directly to the unit 5, without any interrogation procedure according to the prior art.

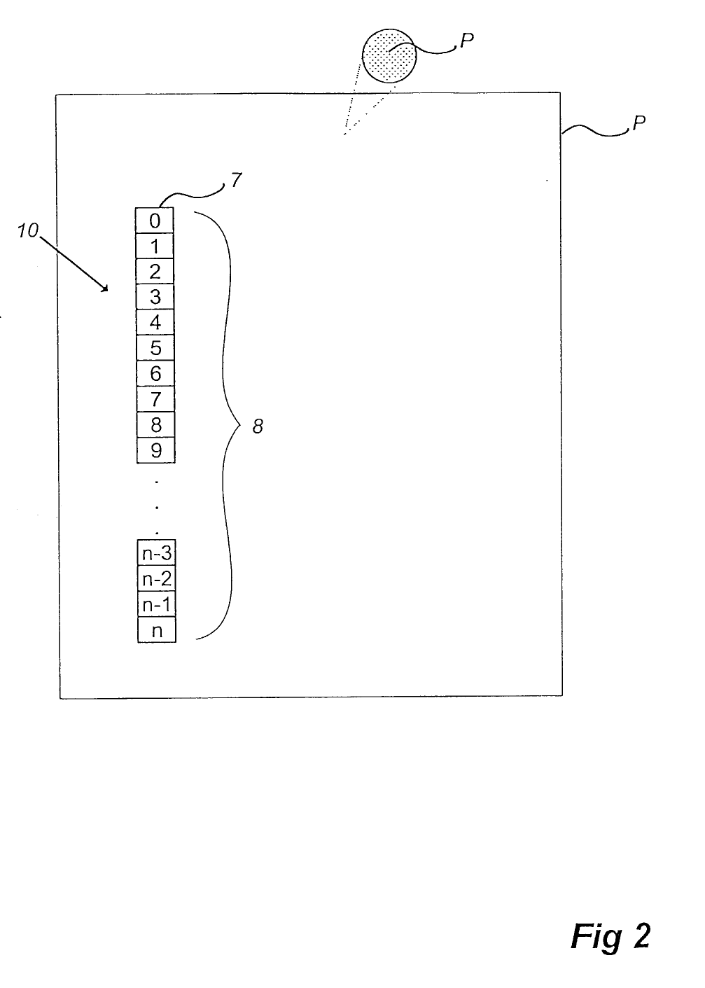

In FIG. 2, there is schematically shown a two-dimensional imaginary surface I, which is defined by the position-coding pattern P and which is thus constituted by all absolute positions, each having an x-coordinate and a y-coordinate, that the position-coding pattern is capable of coding. For example, the position-coding pattern described in WO 01/26032 may define an imaginary surface which is 4.6 million km², where each position is given with a resolution of 0.3 mm.

Furthermore there is shown, in FIG. 2, an addressing area 10 on the imaginary surface I. The addressing area 10 is divided into a series of subareas S₀-Sₙ. The subareas, which in this example are square, are defined by a plurality of pairs of coordinates. Each pair of coordinates thus has a unique belonging to a subarea S₀-Sₙ within the addressing area 10.

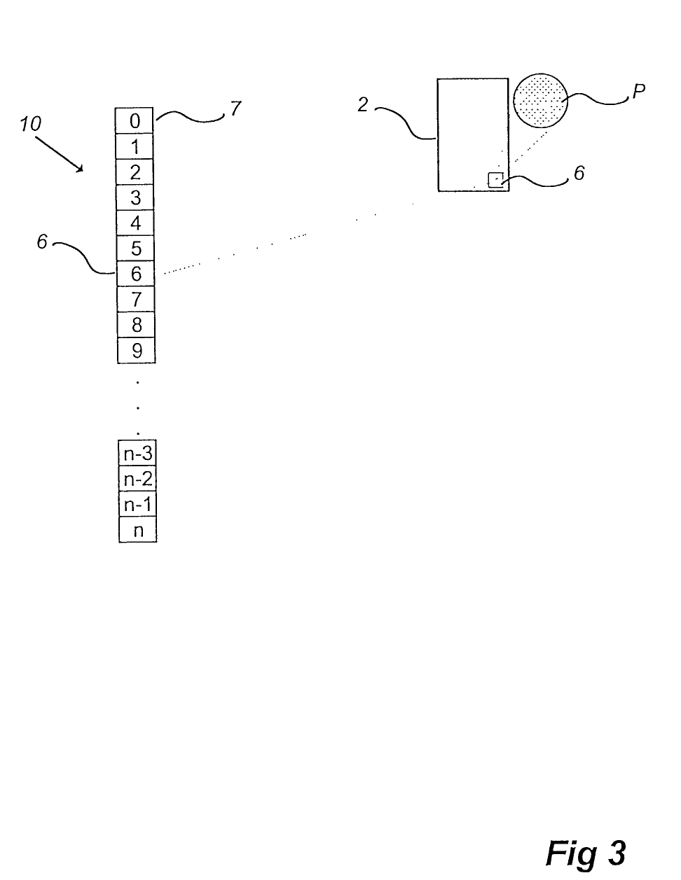

In FIG. 3, it is illustrated how a specific subarea S₄ in the series of subareas S₀-Sₙ within the addressing area 10 on the imaginary surface I, shown in FIG. 2, is connected to a base. This is done by providing the address field 6 of the base 2 with a subset of the position-coding pattern P, which codes one or more pairs of coordinates within the specific subarea S₄ on the imaginary surface I.

The subareas S₀-Sₙ within the addressing area 10 are in the example according to FIGS. 2 and 3 arranged as a linear sequence of neighboring rectangles. All rectangles within the addressing area 10 may be of equal size. A first rectangle S₀ constitutes a starting point for the linear sequence of subareas S₀-Sₙ. This first subarea, S₀, or any one else of the subareas S₀-Sₙ, may constitute a reference subarea. Between the position contents of the subareas S₀-Sₙ is a predetermined mathematical relationship. In the addressing area 10 of FIG. 2, the relationship assumes that the subareas S₀-Sₙ are arranged adjacent to each other, in a linear sequence.

Starting from a recorded pair of coordinates and having knowledge of the pairs of coordinates within the reference sub area S₀, the distance on the imaginary surface I from the recorded pair of coordinates to the reference subarea S₀ may be calculated. Having knowledge of this distance and the size and mutual position of the subareas S₀-Sₙ, the number of subareas S₀-Sₙ between the recorded pair of coordinates and the reference subarea S₀ may be calculated, whereupon a number may be obtained, which corresponds to the location in the linear sequence of the subarea which contains the recorded pair of coordinates.

If the reference subarea S₀ is assigned a first transceiver address or a reference number, each subarea S₀-Sₙ may be assigned a transceiver address which is a function of the transceiver address or reference number of the reference subarea S₀.

Thus, each subarea's S₀-Sₙ offset in relation to the location of a reference subarea S₀ on the imaginary surface I may be utilized for modifying a reference number, such that a number for the subarea S₀-Sₙ is obtained. This number may directly yield a transceiver address, which corresponds to the subarea S₀-Sₙ. Alternatively, it may be modified to provide a transceiver address, which corresponds to the subarea S₀-Sₙ.

The subareas S₀-Sₙ constituting the addressing area 10 may be dedicated for sending, such that the sensor device, when recording a pair of coordinates within any of the subareas S₀-Sₙ, calculates the address and initiates connection and/or sending, without further involvement on the part of the user.

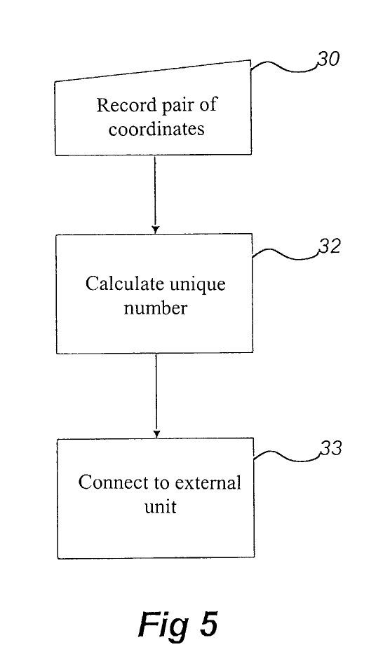

FIGS. 5-7 schematically illustrate flow charts for computer programs which can be stored in a memory 16b, 16c in the signal processor 16 of the sensor device 1 and which can be executed in the processor 16a of the sensor device.

FIG. 5 shows a schematic flow chart for software in a computer program product according to the invention. Via the sensor device, the software records a pair of coordinates on the base 2 in a step 30. Based on the pair of coordinates, a unique number is calculated in step 32 and constitutes the basis for connecting to the external unit 5 in a step 33.

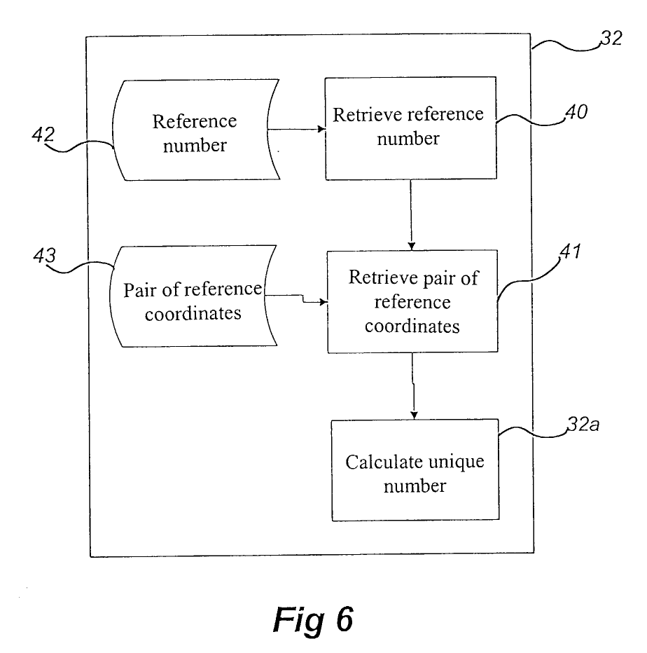

FIG. 6 shows in more detail how step 32 proceeds. A reference number 42 is retrieved in a step 40 from the memory 16b, 16c of the sensor device. A pair of reference coordinates 43 is retrieved in a step 41 from the memory 16b, 16c of the sensor device. The calculation in step 32a of the unique number takes place based on the recorded pair of coordinates, the reference number and the pair of reference coordinates.

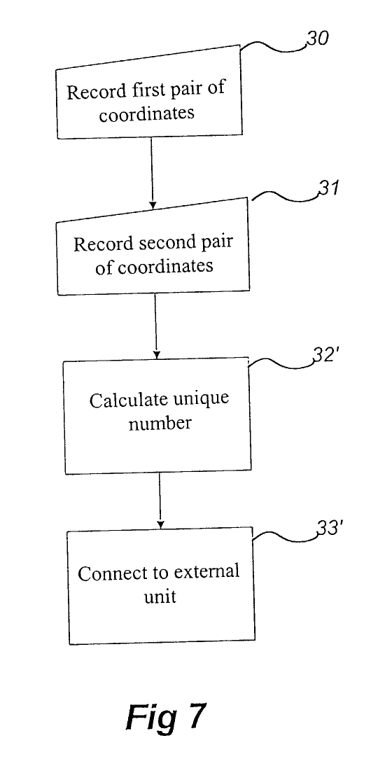

FIG. 7 shows an alternative embodiment of the invention. According to this alternative embodiment, a first and a second pair of coordinates will be recorded in steps 30, 31, the unique number being calculated in a step 32′ based on the two pairs of coordinates and connection taking place based on the unique number in a step 33′.

To illustrate the principle of the invention, three calculation examples will be given below, which illustrate different aspects of the invention. To facilitate legibility, the decimal number system with 10 as a base will be used. The invention is also applicable to other number systems, such as binary or hexadecimal number systems.

Now, assume that an addressing area 10 defined by the corner coordinates (0,0;10,1000) has been plotted to code for transceiver addresses. If each subarea S₀-Sₙ has a size of (w×h)=(10×10), the addressing area 10 comprises one hundred subareas. Now, further assume that the rectangular subarea S₀ which is defined by the corner coordinates (x₀,y₀;x₁,y₁)=(1,1;10,10) constitutes the reference subarea and that this as an example has the transceiver address A₀=095 000. Let A designate the transceiver address to of an arbitrary point.

For one position (xₚ,yₚ)=(5,852), which is recorded by the sensor device, the transceiver address is calculated as follows.

Since the subareas S₀-Sₙ are placed next to each other along the y axis in the coordinate system, the x coordinate of the point can be disregarded, whereby the transceiver address will be as follows

A(_{5,852})=A₀+[(yₚ−y₀)/h]=095 000+[(852−1)/10]=095 000+85=095 085

The transceiver address associated with the recorded position (5,852) is according the example thus 095 085.

According to the alternative embodiment of the present invention, which is illustrated in FIG. 7, the calculated transceiver address is based on inputs of more than one pair of coordinates. According to this embodiment, the transceiver address will be a function of pairs of coordinates within several subareas S₀-Sₙ and a reference subarea.

In order to illustrate this second embodiment, the same assumptions are used as in the first example, with the addition of a second position recorded by the sensor device (x_{q},y_{q})=(4,457) , whereby the transceiver address will be as follows

A(_{5,852;4,457})=A₀+[(yₚ−y₀)/h]+[(y_{q}−y₀)/h]=095 000+85+45=095 125

The transceiver address according to the second embodiment of the invention, based on two recorded pairs of coordinates, will thus be 095 125.

The two, or more, pairs of coordinates can be inputted in many different ways. One way implies that they are recorded within a certain interval and thus interpreted by the sensor device as being associated with each other. Another way implies that the sensor device quite simply accumulates inputs of pairs of coordinates from different subareas S₀-Sₙ until a send command is received or until pairs of coordinates have been inputted from enough subareas S₀-Sₙ to obtain a valid address. According to yet another alternative, the user may, by means of the sensor device 1, connect a plurality of subsets of the position-coding pattern with a line, by passing the sensor device 1 in a continuous movement across the base 2. As a result, a sequence of pairs of coordinates is generated, which extends over and interconnects two or more subareas S₀-Sₙ, in which case a pair of coordinates for each subarea S₀-Sₙ may be extracted and used for the calculation of the unique number. Yet another way may be to set the sensor device in a special mode of operation for calculating a send address. This can take place, for instance, by a button on the sensor device 1 being pressed or by recording a command square on the base. Furthermore, the order in which the inputs are made may be used to indicate how the recorded pairs of coordinates are to be interpreted. The pairs of coordinates can be weighted differently depending on the order in which they are inputted. For instance, the position in the number that is coded can be determined by the order in which the coordinates are inputted. As an example, a sixteen digit number may be inputted by recording four pairs of coordinates, which each represent a four digit group, the first recorded pair of coordinates representing the first four digits, the second inputted pair of coordinates representing the next four digits etc.

Below is a calculation example for an embodiment where more than one address is connected to a subarea S₀-Sₙ, whereby connection or an attempt to connect takes place relative to all the addresses that are indicated by the subarea S₀-Sₙ, which contains the recorded pair of coordinates. The calculation example is based on the first calculation example above. As a further assumption, each subarea S₀-Sₙ is assigned ten transceiver addresses. The calculation will be as follows:

The number that is calculated based on the pair of coordinates of the position recorded by the sensor device 1 is multiplied by a factor 10 according to

A(_{5,852})=A₀+10·[(yₚ−y₀)/h]=095 000+10·[(852−0)/10]=095 850

The first transceiver address is assigned to the subarea containing the pair of coordinates (5,852) which is thus 095 850. The other nine addresses that are assigned to the same subarea by addition of the numbers 1-9, so that the second transceiver address will be 095 851, the third 095 852 etc.

A large number of variations are conceivable within the scope of the invention. For instance, it is possible to arrange the subareas within the addressing area 10 of the imaginary surface I in many different ways and with many different relationships. The important thing is that the unique number can be derived from an arbitrary pair of coordinates within the addressing area. Thus, there are many different possibilities of arranging the reference subarea and the other subareas. Of course, it is also possible to vary the shape and size of the subareas. The subarea can be anything from a point to a surface of a considerable size. When the subarea in the form of a subset of the position-coding pattern is applied to the base, this subset does not need to code all positions within the subarea. For example, the applied subset may code positions within a part of the subarea, if e.g. the address field on the base is smaller than the subarea corresponding to the subset of the position-coding pattern. If, on the other hand, the address field on the base is larger than the subset of the position-coding pattern corresponding to the subarea, it is conceivable to repeat the subset within the address field. The connecting method according to the invention can also be combined with the interrogation procedure according to prior art. For instance, part of an address can be coded according to the invention, in which case a limited number of addresses are obtained, against which interrogation can take place in prior-art manner. This allows, for instance, coding of addresses for a certain type of units or for units of a certain manufacturer.

The invention is also applicable to most conceivable position-coding patterns and sensor devices.

It is also possible to combine the different embodiments and to extend them to comprise, for instance, more inputs to make up the unique number, alternatively a larger or smaller number of address per subarea.

What I claim and desire to secure by Letters Patent is:

1. A method for connecting a sensor device to an arbitrary external unit, said method comprising:
electronically recording by means of the sensor device, on a base provided with at least one subset of a position-coding pattern which codes pairs of coordinates on an imaginary surface, a pair of coordinates within a first subarea among a plurality of subareas within an addressing area on the imaginary surface;
calculating a number for the first subarea based on the pair of coordinates; and
connecting the sensor device to the external unit via an address for electronic communication, which corresponds to the number.

2. The method as claimed in claim 1, wherein the number is based on a mathematical relationship for the locations of said plurality of subareas within the addressing area on the imaginary surface.

3. The method as claimed in claim 2, further comprising retrieving a reference number for a reference subarea among said plurality of subareas from a memory unit, within the sensor device, and calculating the number based on the reference number, the pair of coordinates and the mathematical relationship for the locations of said plurality of subareas on the imaginary surface.

4. The method as claimed in claim 3, further comprising retrieving a pair of reference coordinates for the reference subarea from the memory unit of the sensor device and using said pair of reference coordinates when calculating said number.

5. The method as claimed in claim 1, wherein the address is an address for wireless short range communication.

6. The method as claimed in claim 1, wherein the number is an address for short range data communication.

7. The method as claimed in claim 1, wherein the number is an address for a short range radio link.

8. The method as claimed in claim 1, wherein the number is an address for a short-range infrared link.

9. A method as claimed in claim 1, the method further comprising:
electronically recording by means of the sensor device a second pair of coordinates within a second subarea comprised in the addressing area on the imaginary surface; and
calculating based on the second pair of coordinates a second number for the second subarea, wherein
connecting the sensor device to the external unit is carried out based on a combination of said number and said second number.

10. The method as claimed in claim 1, further comprising deriving, by modification of the number, additional addresses which correspond to the respective subarea within the addressing area.

11. The method as claimed in claim 10, wherein modifying the number comprises a calculating operation which results in a plurality of secondary numbers.

12. A computer program product for carrying out connection of a sensor device to an arbitrary external unit, said computer program product comprising instructions for the sensor device, which instructions, when executed, cause the sensor device to perform the actions of:
electronically recording by means of the sensor device, on a base provided with at least one subset of a position-coding pattern which codes pairs of coordinates on an imaginary surface, a pair of coordinates within a first subarea among a plurality of subareas within an addressing area on the imaginary surface;
calculating a number for the first subarea based on the pair of coordinates; and
connecting the sensor device to the external unit via an address for electronic communication, which corresponds to the number.

13. A device for carrying out connection of a sensor device to an arbitrary external unit, said device comprising a signal processor, which is arranged for:
receiving a pair of coordinates, which is electronically recorded from a base provided with at least a subset of a position-coding pattern, which codes pairs of coordinates on an imaginary surface;
calculating an address for electronic communication based on the position of the pair of coordinates within an addressing area on the imaginary surface; and
connecting the sensor device to the external unit via the calculated address.

14. The device as claimed in claim 13, wherein said signal processor is arranged to calculate, if the pair of coordinates is situated within the addressing area on the imaginary surface, a number for said pair of coordinates, based on its belonging to one of a plurality of subareas within the addressing area, and to convert this number into said address.

15. The device as claimed in claim 14, further comprising a memory in which a mathematical relationship for the locations of said plurality of subareas on the imaginary surface is stored, said signal processor being arranged to calculate said number using said relationship.

16. A method for coding addresses for electronic communication, the method comprising:
allocating an addressing area on an imaginary surface, which is defined by all pairs of coordinates which a position-coding pattern is capable of coding and dividing said addressing area into a plurality of subareas;
assigning a number to each subarea, said number being calculable based on a predetermined mathematical relationship for the positions of the subareas within the addressing area on the imaginary surface; and
with each number, associating an address for electronic communication.

17. The method as claimed in claim 16, further comprising assigning a reference number to a reference subarea among said plurality of subareas, wherein the reference number is utilized for calculating the number.

18. The method as claimed in claim 16, further comprising determining a calculable relationship between the address and the number.

19. The method as claimed in claim 16, wherein the address is identical with the number.

20. The method as claimed in claim 16, wherein the division of the addressing area into a plurality of subareas is performed such that the subareas are arranged as a sequence of neighboring subareas on the imaginary surface.

21. A device for addressing electronic communication equipment, said device comprising:
a base provided with at least one subset of a position-coding pattern which codes pairs of coordinates on an imaginary surface;
wherein the subset of the position-coding pattern, which is arranged on the base, corresponds to a subarea among a plurality of subareas within an addressing area on the imaginary surface;
wherein a number is assigned to each such subarea, said number being calculable based on an arbitrary pair of coordinates within the subarea and a predetermined mathematical relationship for the locations of the subareas within the addressing area; and
wherein the number is associated with an address for electronic communication.

22. The device as claimed in claim 21, wherein the subarea is comprised in a sequence of subareas within the addressing area on the imaginary surface, such that the location of each subarea within the addressing area is calculable in relation to a reference area associated therewith.

23. The device as claimed in claim 21, said address for electronic communication being calculable based on said number.

24. The device as claimed in claim 21, wherein the number is an address for wireless short-range communication.

25. A device for carrying out connection of a sensor device to an arbitrary external unit, said device comprising:
means for receiving a pair of coordinates, which is electronically recorded from a base provided with at least a subset of a position-coding pattern, which codes pairs of coordinates on an imaginary surface;
means for calculating an address for electronic communication based on the position of the pair of coordinates within an addressing area on the imaginary surface; and
means for connecting the sensor device to the external unit via the calculated address.

26. The device as claimed in claim 25, wherein said means for receiving, calculating and connection and said means for electronic recording of the pair of coordinates are arranged in one physical unit.
